(19) United States
(12) Patent Application Publication
(10) Pub. No.: US 2013/0326006 A1
(43) Pub. Date: Dec. 5, 2013

(54) MANAGING LARGE DATA SETS THROUGH PAGE BASED INFORMATION TRACKING IN MULTI-MASTER ENVIRONMENTS

(71) Applicants: Ilya Grebnov, Bellevue, WA (US); Charles Lamanna, Bellevue, WA (US); Michael Wilde, Bothell, WA (US)

(72) Inventors: Ilya Grebnov, Bellevue, WA (US); Charles Lamanna, Bellevue, WA (US); Michael Wilde, Bothell, WA (US)

(73) Assignee: Microsoft Corporation, Redmond, WA (US)

(21) Appl. No.: 13/487,883

(22) Filed: Jun. 4, 2012

(51) Int. Cl. G06F 15/16

(52) U.S. Cl. 709/217

(57) ABSTRACT

A data store receives a page cookie as a request for a page of records. The page cookie acts as a container to a record identifier of a last retrieved record and a timestamp of the last change to the record. The data store identifies retrieved pages to skip over according to a comparison of date, time and data instance name/write-master information for each record in the retrieved pages against the information in the page cookie. The data stamp contains information about the timestamp of last change to the record and data store instance name of the record. Subsequent to finding a matching record, the data store creates a new page cookie based on the page containing the record and transmits the new page cookie and the page to the requester.

### BACKGROUND

Modern markets are saturated by user driven data consumption. Applications integrate media and user information from variety of sources to congregate resources in order to meet customer demand. Video and audio information consume warehouses of systems providing instantaneous access to user data across the world. User organized information require resource intensive systems to accommodate the demand. In addition, enterprise requirements complicate information storage and retrieval by inserting business requirements into the storage systems. Data reliability and analysis requirements generate additional and duplicate data for data systems already taxed with meeting user demands. Reliability requirements extend data storage by creating redundancy that consumes expensive resources.

Databases manage and provide data services to control data redundancy and reliability. Databases can generate multiple instances to meet customer rules and demand. Data retrieval through paging is a pattern in SQL. Paging allows splitting of data retrieval data to multiple pages instead of a single retrieval from the database. Each page may be requested from a different instance of the database according to business rules. Databases with multiple instances create further complexities to providing continued data retrieval services through paging while minimizing redundancy. In a database environment hosting multiple instances, a request for a next page can fail as a result of the pages being distributed across multiple servers and platforms.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to managing data sets through page based information tracking. According to some embodiments, an application may receive a page cookie as a request for a page of records. The application may be a database store provider serving multiple instances of a data store. The application may identify retrieved pages from records by using the page cookie and date/time and data instance name/write-master information associated with the retrieved pages. The records may be queried through multiple instances of the data store. The requested page may be located by skipping the retrieved pages. Next, the application may create a new page cookie based on the page. The page cookie may have a record identifier and a timestamp for last retrieved record within the page. Subsequently, the application may transmit the new page cookie and the page to the requester.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates a networked environment, where an application may manage data sets through page based information tracking according to some embodiments;

FIG. 2 illustrates a component diagram establishing management of data sets through page based information tracking according to embodiments;

FIG. 3 illustrates an action diagram of an application managing data sets through page based information tracking according to embodiments;

FIG. 4 is a networked environment, where a system according to embodiments may be implemented;

FIG. 5 is a block diagram of an example computing operating environment, where embodiments may be implemented; and

FIG. 6 illustrates a logic flow diagram for a process managing data sets through page based information tracking according to embodiments.

### DETAILED DESCRIPTION

As briefly described above, an application may manage data sets through page based information tracking. The application may receive a page cookie as a request for a page of records. The page of records may contain one or more records such as a row of data from a data table of a data store. The same data may be available in stores instances, and any of the stores instances may be used to retrieve next page. The application may identify retrieved pages from records by using the page cookie and data stamps associated with the records. The application may analyze a record identifier within the page cookie to find matching records partitioned to pages. The application may locate the page by skipping the retrieved pages. Subsequently, the application may create a new page cookie based on the identified page for transmission. The new page cookie may have a timestamp and a new record identifier marking a last retrieved record for the page. Furthermore, the application may transmit the new page cookie and the page to a requester. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present disclosure is defined by the appended claims and their equivalents.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present disclosure is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a non-transitory computer-readable memory device. The computer-readable storage medium can for example be implemented via one or more of a volatile computer memory, a non-volatile memory, a hard drive, a flash drive, a floppy disk, or a compact disk, and comparable media.

According to embodiments, a page may contain one or more records. A record may be a row of data from a data table of a data store. The application may be a data store application managing a data store. The data store may be a database, a flat file, a spreadsheet, a data cube, or other data entity. The data store may have one or more instances running concurrently. The instances may be distributed across platforms and may each be identified by a name. Each record may have a data stamp. The data stamp may have a timestamp value and data store instance name. The data stamp may be part of the record as values in additional columns within a data table. In addition, the page cookie used to request and track transmitted pages may contain a record identifier and a timestamp of a last retrieved record within the page. A page cookie may have multiple timestamps and last retrieved record ids, one for every store instance.

Throughout this specification, the term “platform” may be a combination of software and hardware components for managing data sets through page based information tracking. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

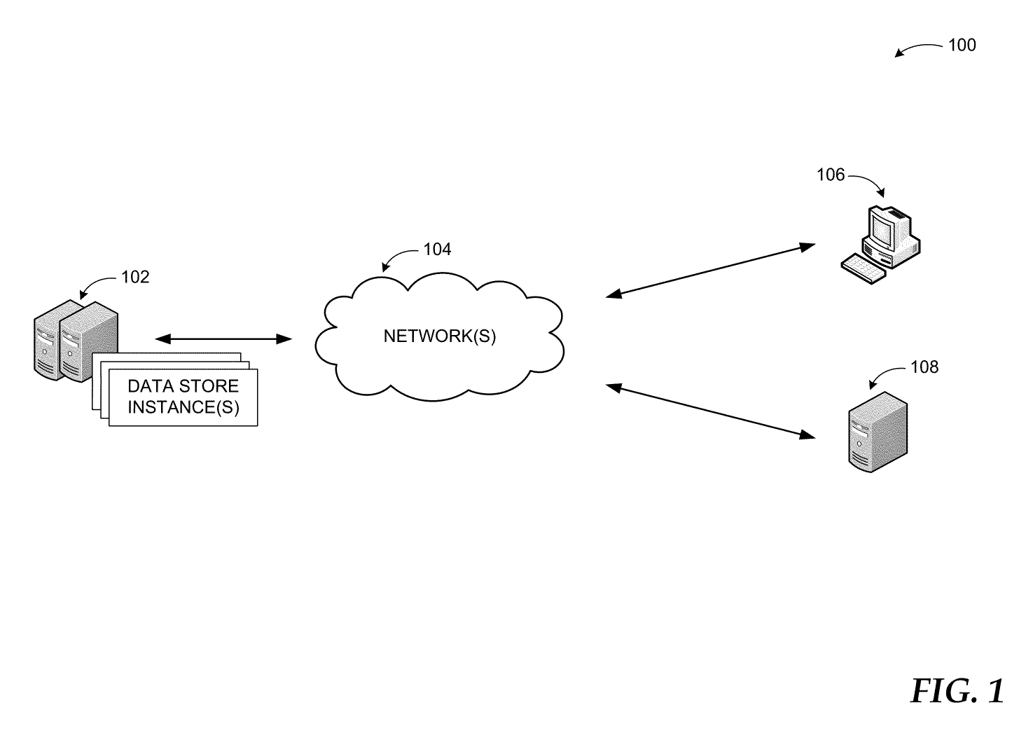

Referring to FIG. 1, diagram 100 illustrates a networked environment, where an application may manage data sets through page based information tracking according to some embodiments. The computing devices and computing environments shown in diagram 100 are for illustration purposes. Embodiments may be implemented in various local, networked, cloud-based and similar computing environments employing a variety of computing devices and systems, hardware and software.

In an example environment illustrated in diagram 100, a client device 106 may request a page of records from data store instance(s) 102. The client device 106 may be an end user device such as desktop computer. Alternatively, the client device may be an intermediary consumer such as a server 108. Both client devices 106 and 108 may use network(s) 104 to communicate with the data store instance(s) 102. A data store may have multiple instances running concurrently across multiple servers or other hardware devices. The data store instance(s) may replicate records to serve multiple requirements such as availability and data reliability. Data reliability may be ensured through back-up systems that go into service seamlessly to a client device in case of primary data store server outage.

The client device may include a variety of devices including a desktop computer, a laptop computer, a slate, a smart phone, and a server 108. In addition, a client application executed within the client device may request the page from the data store instance(s) 102. The client application may be a stand-alone application or it may be a client interface for the data store instance(s) 102. In addition the client application may use an application programming interface (API) to communicate with the data store instance(s) 102. The data store instance(s) 102 may have multiple instances as described above. In addition, the data store may provide data services within a distributed environment managing data requests to varying hardware and software components according to load requirements and organizational requirements such as compartmentalized data access.

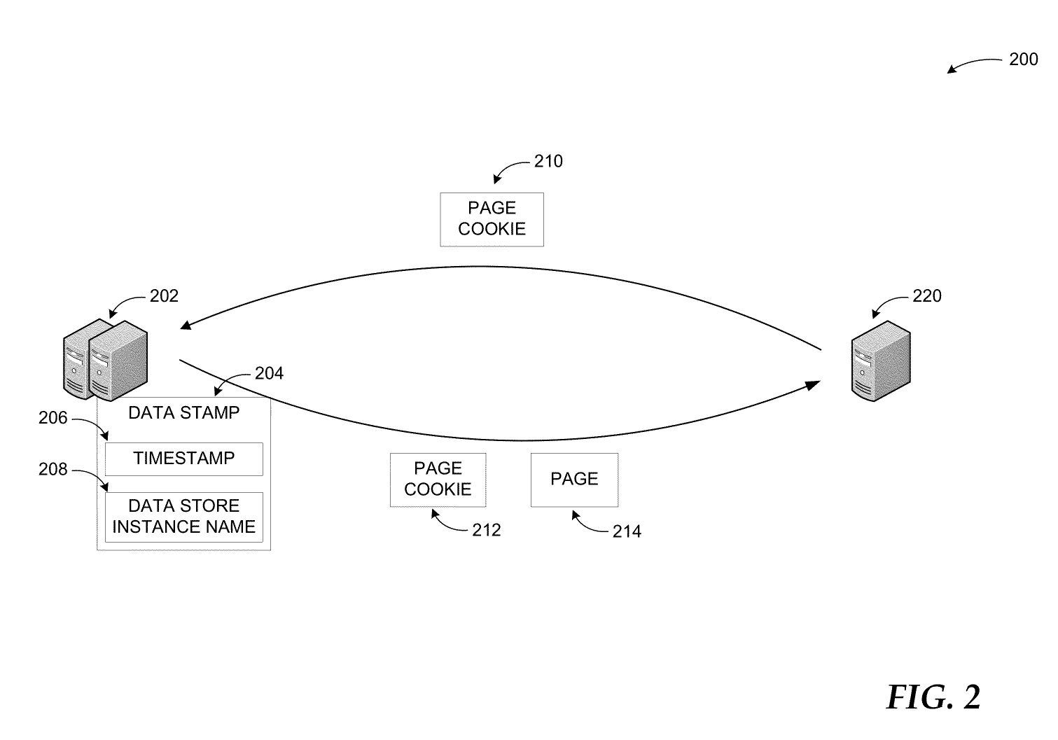

FIG. 2 illustrates a component diagram establishing management of data sets through page based information tracking according to embodiments. Diagram 200 displays flow process for components of page request and transmission through a page cookie. The page cookie may include a timestamp and a record identifier to mark the last retrieved record from a data store. The timestamp may have date and time values to mark the time of last change applied to the record.

A client device such as server 220 may initiate a page request by transmitting a page cookie 210 to the data store. The page cookie 210 may be a container. The page cookie 210 may have a record identifier and a timestamp to identify the last retrieved record. Alternatively the page cookie may be empty to indicate that no prior pages of records were requested.

The data store 202 may receive the page cookie and analyze it against stored records. The data store, may read data stamp 204 of each record to assess whether the record belongs to retrieved pages. The data stamp 204 may have a timestamp value 206 and a data store instance name 208. Timestamp value 206 and a data store instance name 208 may be updated together as a record of who changed the record last. The data store may identify a record through the record identifier within the page cookie 210. In addition, the data store may compare the timestamp of the page cookie 210 and the timestamp of data stamp 204 of the record to determine the record as belonging to a retrieved page. The data store may skip the retrieved page(s) subsequent to identification. After skipping retrieved page(s), the record store may retrieve a new page 214 not previously transmitted to the client device.

According to some embodiments, a page of records may be a predetermined number of records. The number of records may be determined according to data store settings. Alternatively, the size of the page 214 may be determined dynamically according to system and organization requirements. In an example scenario, the page size may be increased or decreased according to hardware limitations such as available bandwidth. In another example scenario, the page size may be increased or decreased according to security requirements and authentication of the client device.

After locating a page 214 to be transmitted to the client, the data store may create a new page cookie 212 with information about the page 214. The new page cookie may have a timestamp of a last retrieved record within the page 214. The page cookie 212 may also have the record identifier of the last retrieved record. Next, the data store may fulfill the client request by transmitting the new page cookie 212 and the page 214 to the client device.

According to other embodiments, the page may include one or more records. A record may include a data stamp. The data store may read a data stamp of each record to identify the page of records to be transmitted to the client device. The data stamp may include a time stamp of a last change of a record and a data store instance name of the record. The data store may sort the records according to the timestamp value of the data stamp.

According to yet other embodiments, the data store may identify the page by selecting a subset of records matching the record identifier within the page cookie. The record identifier may be a record number allocated by the data store. The data store may compare the timestamp of the page cookie to the timestamp of the last change of the record for each record within the subset to identify the requested page. The data store may select a record with a timestamp of a last change of the record closest to the timestamp of the page cookie. The data store may select the page containing the record. Additionally, the timestamp within the cookie or a timestamp of a last change of a record within the data stamp may include a date value and a time value.

According to other embodiments, a data store may include SQL procedures to realize page cookie based retrieval of a page of records. Although not provided as a limiting example, the following may be an example pseudo code procedure to realize a page cookie:

ALTER PROCEDURE dbo.[FindPagedSOMEDATA]

| | |
|---|---|
| ,@PageCookie | NVARCHAR(MAX) INPUT/OUTPUT |
| ,@PageSize | INT INPUT |

```
AS
  BEGIN
      -- Reading new page
      SELECT TOP (SELECT @PageSize)
        [SOMECOLUMNS]
      FROM
        [SOMETABLE] AS TBL
      LEFT OUTER JOIN
        @PageCookie AS PC
      ON
        PC.DatastoreName = TBL.ChangedDatastoreName
      WHERE
        PC.LastChangedDatetime IS NULL OR
        PC.LastChangedDatetime < TBL.ChangedDatetime
      ORDER BY
        TBL.ChangedDatetime ASC
      ;
      -- Creating new pagecookie
      WITH
        CTE_LastChangedDatetime(DatastoreName,
        LastChangedDatetime) AS
        (
          SELECT
            ChangedDatastoreName
            ,MAX(ChangedDatetime)
          FROM
            [NEXTPAGE]
          GROUP BY
            ChangedDatastoreName
        ),
      MERGE
        @tv_Cookie as PC
      USING
        CTE_LastChangedDatetime AS CTE
      ON
        PC.DatastoreName = CTE.DatastoreName
      WHEN MATCHED THEN
        UPDATE SET
          PC.LastChangedDatetime =
          CTE.LastChangedDatetime
      WHEN NOT MATCHED THEN
        INSERT
          (DatastoreName, LastChangedDatetime)
        VALUES
          (nvc_DatastoreName, CTE.LastChangedDatetime)
      ;
  END
```

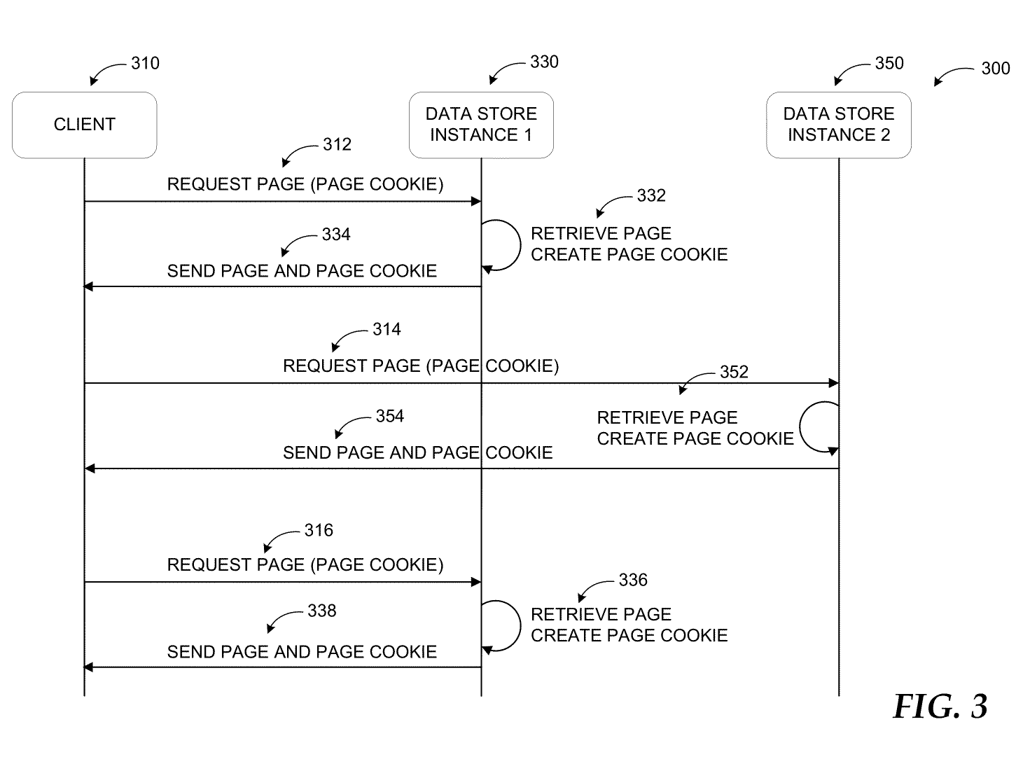

FIG. 3 illustrates an action diagram of an application managing data sets through page based information tracking according to embodiments. Diagram 300 displays a client 310, data store instance (DSI) 1 (330) and data store instance (DSI) 2 (350) in interaction.

An example client 310 may request a page through a page cookie 312. In an example scenario the page cookie from request 312 may be empty in order to request the first page of the DSI 1 (330). The DSI 1 (330) may analyze the page cookie for record identifier and timestamp of the record. For an empty page cookie, the DSI 1 may retrieve an initial page 332 from the data store and create a page cookie with information about the retrieved initial page. Subsequently, the DSI 1 (330) may send the page and the page cookie 334 to the client 310.

In a subsequent request, the client 310 may request a page 314 including record identifier and timestamp values within the page cookie. The record identifier may refer to the last retrieved record. The client may query the DSI 2 (350) for the page. The page requested may include one or more records with data stamps. The data stamps may have DSI 2 (350) as the data store instance name. The DSI 2 (350) may locate the page having the record referred in the page cookie. Subsequently, the DSI 2 (350) may retrieve the page and create a page cookie 352 with information from the page. Next, the page and page cookie may be sent 354 to the client 310.

In a follow-up request, the client 310 may request for a refresh of a requested page 316. The DSI 1 (330) may retrieve the page and create a page cookie (336) if there are any updates to the records within the page. The DSI 1 (330) may send the updated page and the page cookie 338 to the client 310.

According to some embodiments, a data store may update a data stamp of a record upon detecting a change in the record. The data store may update a timestamp of a last change of a record with a current time. Additionally, the data store may update the data store instance name of the record with a current data store instance name of the record.

According to other embodiments, the data store may sort each record according to the timestamp of the last change of a record. The data store may sort the records in descending order according to the timestamp of the last change nearest to a current time value. Alternatively, the data store may sort the records in ascending order according to the timestamp of the last change furthest from the current time value. Furthermore, the data store may group each record according to a data store instance name of each record.

In yet other embodiments, the data store may detect a collision between records distributed across multiple data store instances registering differing timestamps for last change values. The data store may detect the collision by identifying records matching the same record identifier within a page cookie. The data store may resolve the conflict by selecting the record from the subset with the timestamp of the last change closest to the timestamp of the page cookie.

According to some embodiments, data stamps may be created initially and then a row inserted. Thus, a time stamp (at creation) may be defined as the time when the row is created and an instance may be defined as instance name for who inserted the row. Later, data stamps may be updated and then row(s) updated and/or inserted. Thus, a time stamp may be defined as the time when a row is updated/inserted (subsequently) and an instance may be defined as the instance name of who updated a row. As soon as a record is created, updated, or deleted, information may need to be transferred to other instances. Thus, replication from source to all destinations may be started. During replication, a record on destination (including data stamp data) may be updated to same value as in the source. After a short period of time all instances may have the same view of record including information about who updated a record and when.

The example scenarios and schemas in FIGS. 2 and 3 are shown with specific components, data types, and configurations. Embodiments are not limited to systems according to these example configurations. Managing data sets through page based information tracking may be implemented in configurations employing fewer or additional components in applications and user interfaces. Furthermore, the example schema and components shown in FIGS. 2 and 3 and their subcomponents may be implemented in a similar manner with other values using the principles described herein.

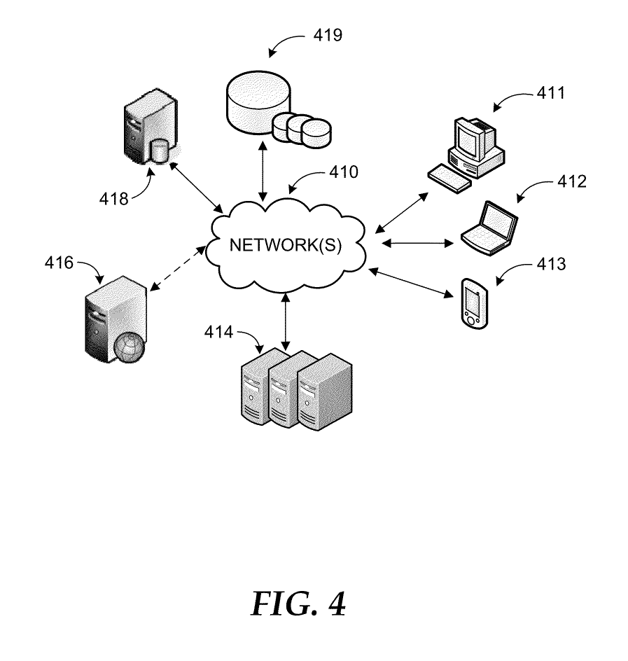

FIG. 4 is a networked environment, where a system according to embodiments may be implemented. Local and remote resources may be provided by one or more servers 414 or a single server (e.g. web server) 416 such as a hosted service. An application may communicate with client interfaces on individual computing devices such as a smart phone 413, a laptop computer 412, or desktop computer 411 (‘client devices’) through network(s) 410.

As discussed above, an application may manage data sets through page based information tracking. The page cookie may have a record identifier and a timestamp of the last retrieved record. Data stamps of records in the data store may contain a timestamp of last change of the record and data store instance name. Client devices 411-413 may enable access to applications executed on remote server(s) (e.g. one of servers 414) as discussed previously. The server(s) may retrieve or store relevant data from/to data store(s) 419 directly or through database server 418.

Network(s) 410 may comprise any topology of servers, clients, Internet service providers, and communication media. A system according to embodiments may have a static or dynamic topology. Network(s) 410 may include secure networks such as an enterprise network, an unsecure network such as a wireless open network, or the Internet. Network(s) 410 may also coordinate communication over other networks such as Public Switched Telephone Network (PSTN) or cellular networks. Furthermore, network(s) 410 may include short range wireless networks such as Bluetooth or similar ones. Network(s) 410 provide communication between the nodes described herein. By way of example, and not limitation, network(s) 410 may include wireless media such as acoustic, RF, infrared and other wireless media.

Many other configurations of computing devices, applications, data sources, and data distribution systems may be employed to manage data sets through page based information tracking. Furthermore, the networked environments discussed in FIG. 4 are for illustration purposes only. Embodiments are not limited to the example applications, modules, or processes.

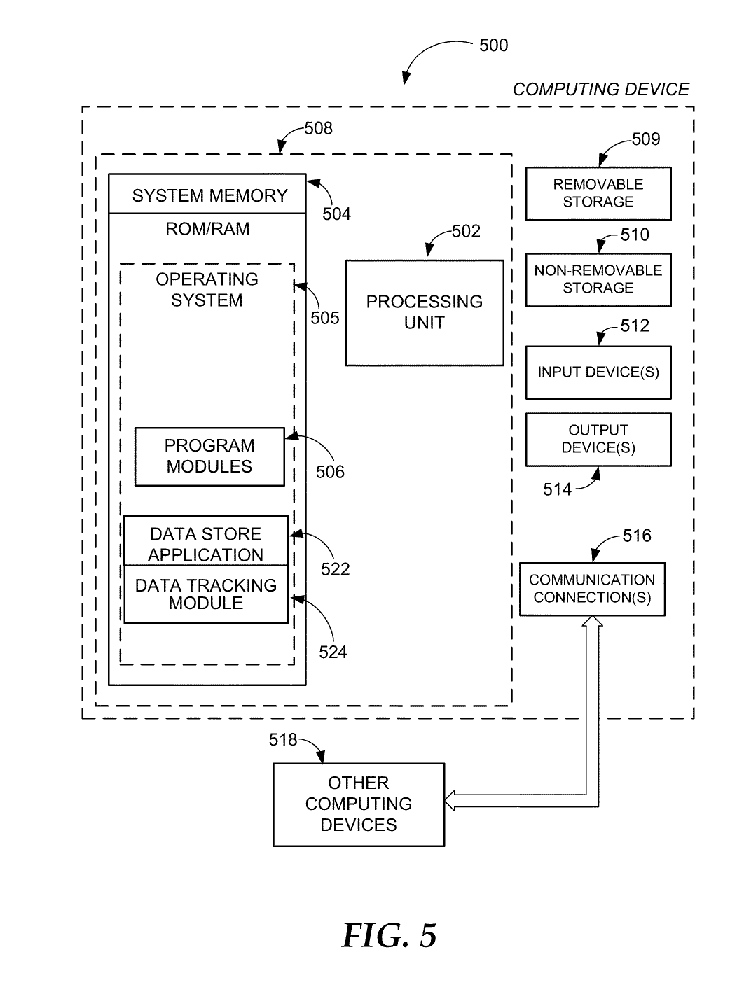

FIG. 5 and the associated discussion are intended to provide a brief, general description of a suitable computing environment in which embodiments may be implemented. With reference to FIG. 5, a block diagram of an example computing operating environment for an application according to embodiments is illustrated, such as computing device 500. In a basic configuration, computing device 500 may include at least one processing unit 502 and system memory 504. Computing device 500 may also include a plurality of processing units that cooperate in executing programs. Depending on the exact configuration and type of computing device, the system memory 504 may be volatile (such as RAM), non-volatile (such as ROM, flash memory, etc.) or some combination of the two. System memory 504 typically includes an operating system 505 suitable for controlling the operation of the platform, such as the WINDOWS® operating systems from MICROSOFT CORPORATION of Redmond, Wash. The system memory 504 may also include one or more software applications such as program modules 506, data store application 522, and data tracking module 524.

Data store application 522 may store records and allocate them to pages according to embodiments. The data tracking module 524 may analyze page cookies and data stamps to provide page of records. The data tracking module 524 may also manage and update timestamps, data store instance names and record identifiers. This basic configuration is illustrated in FIG. 5 by those components within dashed line 508.

Computing device 500 may have additional features or functionality. For example, the computing device 500 may also include additional data storage devices (removable and/or non-removable) such as, for example, magnetic disks, optical disks, or tape. Such additional storage is illustrated in FIG. 5 by removable storage 509 and non-removable storage 510. Computer readable storage media may include volatile and nonvolatile, removable and non-removable media implemented in any method or technology for storage of information, such as computer readable instructions, data structures, program modules, or other data. Computer readable storage media is a non-transitory computer readable memory device. System memory 504, removable storage 509 and non-removable storage 510 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer readable storage media may be part of computing device 500. Computing device 500 may also have input device(s) 512 such as keyboard, mouse, pen, voice input device, touch input device, and comparable input devices. Output device(s) 514 such as a display, speakers, printer, and other types of output devices may also be included. These devices are well known in the art and need not be discussed at length here.

Computing device 500 may also contain communication connections 516 that allow the device to communicate with other devices 518, such as over a wireless network in a distributed computing environment, a satellite link, a cellular link, and comparable mechanisms. Other devices 518 may include computer device(s) that execute communication applications, storage servers, and comparable devices. Communication connection(s) 516 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be co-located with each other, but each can be only with a machine that performs a portion of the program.

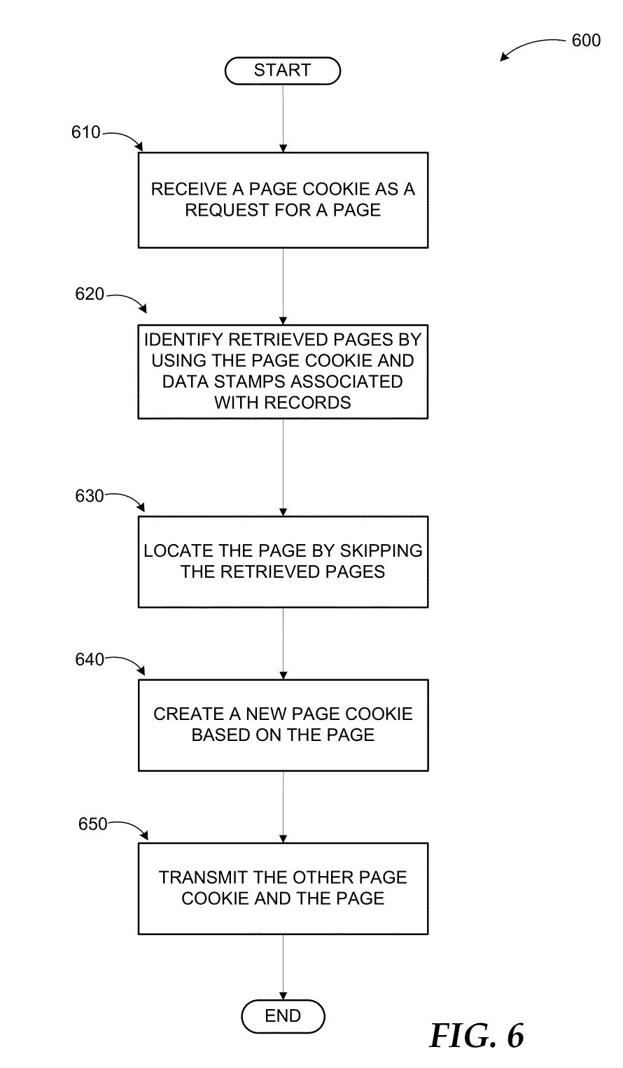

FIG. 6 illustrates a logic flow diagram for a process managing data sets through page based information tracking according to embodiments. Process 600 may be implemented by a data store application in some examples.

Process 600 may begin with operation 610 where the data store may receive a page cookie as a request for a page. The page cookie may include a record identifier of last retrieved record and a timestamp of a last change of the record. At operation 620, the data store may identify retrieved pages from records by using the page cookie and data stamps associated with the retrieved pages. Each record in the retrieved pages may have data stamps which may contain timestamps matching the timestamp in the page cookie. Next, the data store may locate the page by skipping the retrieved pages at operation 630. The data store may create a new page cookie based on the located page at operation 640. The new page cookie may have the record identifier of the last retrieved record of the page. Subsequently, the data store may transmit the new page cookie and the page to the requester at operation 650.

Some embodiments may be implemented in a computing device that includes a communication module, a memory, and a processor, where the processor executes a method as described above or comparable ones in conjunction with instructions stored in the memory. Other embodiments may be implemented as a computer readable storage medium with instructions stored thereon for executing a method as described above or similar ones.

The operations included in process 600 are for illustration purposes. Managing data sets through page based information tracking may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed on a computing device for managing data sets through page based information tracking, the method comprising:
receiving a page cookie as a request for a page from an application;
reading a data stamp of each record that includes a timestamp of a last change of the record and a data store instance name of the record;
identifying retrieved pages from records based on the page cookie and data stamps associated with each of the records;
locating the page by skipping the retrieved pages based on the data stamps;
creating another page cookie based on the page and a previous page cookie value; and
transmitting the other page cookie and the page to the requesting application.

2. The method of claim 1, wherein the page includes at least one record and each record includes a data stamp, the data stamp including information associated with date, time, and store instance.

3. The method of claim 1, further comprising:
associating one of a write-master and a data-instance where the change occurred for every record in conjunction with one or more of paging, synchronizing data, and replicating data.

4. The method of claim 1, further comprising:
filtering data one of prior to and following application of a paging function.

5. The method of claim 1, further comprising:
reading a record identifier and a timestamp of each record from the page cookie.

6. The method of claim 5, wherein the record identifier identifies a last retrieved record.

7. The method of claim 1, further comprising:
selecting a subset of the records matching with a record identifier within the page cookie.

8. The method of claim 7, further comprising:
comparing a timestamp of the page cookie to a timestamp of a last change of each record within the subset.

9. The method of claim 8, further comprising:
selecting a record with a timestamp of a last change of the record closest to the timestamp of the page cookie.

10. The method of claim 9, further comprising:
selecting the page based on the page including the record.

11. The method of claim 1, wherein a timestamp within the page cookie and a timestamp of a last change of a record within a data stamp include a date value and a time value.

12. A computing device for managing data sets through page based information tracking, the computing device comprising:
a memory configured to store instructions; and
a processor coupled to the memory, the processor executing an application in conjunction with the instructions stored in the memory, wherein the application is configured to:
receive a page cookie as a request for a page from another application;
select a subset of records associated with a record identifier within the page cookie;
compare a timestamp of the page cookie to a data stamp including a timestamp of a last change of a record and a data store instance name of the record for each record within the subset;
select a record from the subset with a timestamp of a last change of the record closest to the timestamp of the page cookie;
select a page that includes the record;
create another page cookie based on the page; and
transmit the other page cookie and the page to the other application.

13. The computing device of claim 12, wherein the application is further configured to:
update the timestamp of the last change of the record with a current time value and a data store instance name of the record with a current data store instance name of the record subsequent to detecting a change in the record.

14. The computing device of claim 12, wherein the application is further configured to:
sort the records according to one of: a timestamp of a last change for each record and a timestamp of a last change nearest to a current time value in a descending order.

15. The computing device of claim 12, wherein the application is further configured to:
update data stamp data of each record upon replication on a destination with a same value as at a source.

16. The computing device of claim 12, wherein the application is further configured to:
group the records based on a data store instance name of each record.

17. A computer-readable memory device with instructions stored thereon for managing data sets through page based information tracking, the instructions comprising:
receiving a page cookie as a request for a page of records from an application;
selecting a subset of records associated with a record identifier within the page cookie;
comparing a timestamp of the page cookie to a data stamp including a timestamp of a last change of a record and a data store instance name of the record for each record within the subset;
selecting a record from the subset with a timestamp of a last change of the record closest to the timestamp of the page cookie;
selecting a page that includes the record;
creating another page cookie based on the page;
transmitting the other page cookie and the page the requesting application; and
sorting the records based on a timestamp of a last change of each record.

18. The computer-readable memory device of claim 17, wherein the instructions further comprise:
detecting a collision as a result of retrieving the subset from a plurality of data store instances and matching a record identifier within the page cookie to the subset.

19. The computer-readable memory device of claim 18, wherein the instructions further comprise:
resolving the collision by selecting a record from the subset with the timestamp of the last change of the record closest to the timestamp of the page cookie.

20. The computer-readable memory device of claim 17, wherein the instructions further comprise:
transmitting a first page from the records upon detecting an empty page cookie.
